(19) United States
(12) Patent Application Publication
(10) Pub. No.: US 2019/0230190 A1
(43) Pub. Date: Jul. 25, 2019

(54) INFORMATION PROCESSING APPARATUS, DATA DISTRIBUTION SYSTEM AND COMPUTER READABLE MEDIUM

(71) Applicant: FUJI XEROX CO., LTD., Tokyo (JP)

(72) Inventor: Takeshi NOGUCHI, Yokohama-shi (JP)

(73) Assignee: FUJI XEROX CO., LTD., Tokyo (JP)

(21) Appl. No.: 16/243,418

(22) Filed: Jan. 9, 2019

(30) Foreign Application Priority Data
Jan. 23, 2018 (JP) 2018-008958
Jan. 24, 2018 (JP) 2018-009261

(51) Int. Cl. H04L 29/08; H04L 29/06

(52) U.S. Cl. CPC H04L 67/32; H04L 67/42; H04L 67/1002

(57) ABSTRACT

An information processing apparatus includes: receiving unit that receives a process request; and a process execution unit that executes a process in accordance with the process request received by the receiving unit. In a case where, while the process execution unit is executing a process in accordance with a process request, the receiving unit receives another process request a process content in accordance with which being same as a process content of the process request that is being executed, the process execution unit does not execute the other process request received by the receiving unit.

### CROSS-REFERENCE TO RELATED APPLICATIONS

This application is based on and claims priority under 35 USC 119 from Japanese Patent Application No. 2018-009261 filed on Jan. 24, 2018 and Japanese Patent Application No. 2018-008958 filed on Jan. 23, 2018.

### BACKGROUND

### Technical Field

The present invention relates to an information processing apparatus, a data distribution system and a computer readable medium.

### Related Art

JP-T-2005-532748 and JP-A-2010-148118 disclose a distribution service which distributes digital contents, for instance, video, music, software or the like by ensuring a service quality in a router of a core of a dispersion type network.

### SUMMARY

Aspect of non-limiting embodiments of the present disclosure relates to provide an information processing apparatus, a data distribution system and a computer readable medium that may prevent a useless process request from being executed in transmitting a process request to a process execution apparatus that executes a process in accordance with the received process request to execute a specific process.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a receiving unit that receives a process request; and a process execution unit that executes a process in accordance with the process request received by the receiving unit, wherein, in a case where, while the process execution unit is executing a process in accordance with a process request, the receiving unit receives another process request a process content in accordance with which being same as a process content of the process request that is being executed, the process execution unit does not execute the other process request received by the receiving unit.

### BRIEF DESCRIPTION OF THE DRAWINGS

Exemplary embodiment(s) of the present invention will be described in detail based on the following figures, wherein:

FIG. 1 is a view illustrating a system structure of a data distribution system of a first exemplary embodiment of the present invention;

FIG. 2 is a conceptual view illustrating a transmitting and receiving method of a process request in the data distribution system according to the first exemplary embodiment;

FIG. 3 is a block diagram illustrating a hardware structure of a data processing server 10 according to the first exemplary embodiment;

FIG. 4 is a block diagram illustrating a functional structure of the data processing server 10 according to the first exemplary embodiment;

FIG. 5 is a flowchart for explaining an operation of the data processing server 10 according to the first exemplary embodiment;

FIG. 6 is a block diagram illustrating a hardware structure of a client terminal 20 according to a second exemplary embodiment of the present invention;

FIG. 7 is a block diagram illustrating a functional structure of the client terminal 20 according to the second exemplary embodiment; and

FIG. 8 is a flowchart for explaining an operation of the client terminal 20 according to the second exemplary embodiment.

### DETAILED DESCRIPTION

Exemplary embodiments of the present invention will be described below in detail by referring to the drawings.

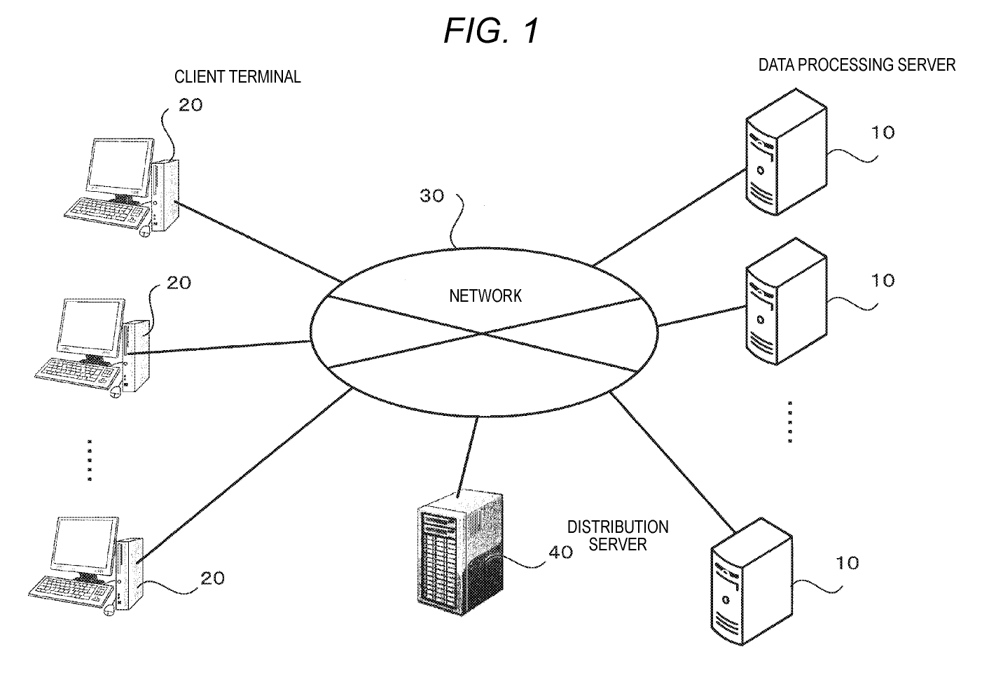

FIG. 1 is a view illustrating a system structure of a data distribution system according to a first exemplary embodiment of the present invention.

The data distribution system according to the first exemplary embodiment includes, as shown in FIG. 1, plural data processing servers 10, plural client terminals 20 and a distribution server 40 connected to each other by a network 30.

The plural client terminals 20 respectively generate and transmit process requests which request a specific processing to image data, audio data and text data to be executed.

The distribution server 40 receives the process request from the client terminal 20 and distributes the received process request to a data processing server 10 which can execute the process request from among the plural data processing servers 10.

Each of the data processing servers 10 is an information processing apparatus configured to execute a process to various data such as the image data, the audio data and the text data.

For instance, a certain data processing server 10 is configured so as to execute an image process to the image data. Other data processing server 10 is formed so as to execute an audio recognition process to the audio data. Further, other process contents which can be executed by the data processing server 10 include various kinds of process contents such as a key word extraction process to the text data, a character recognition process to the image data or a process which extracts a characteristic key frame from the image data.

In the data distribution system of the first exemplary embodiment of the present invention, between the client terminal 20, the distribution server 40 and the data processing server 10, a message of the process request is transmitted and received through a communication protocol of MQTT (Message Queue Telemetry Transport) which executes a Pub/Sub (Publish/Subscribe model) data distribution.

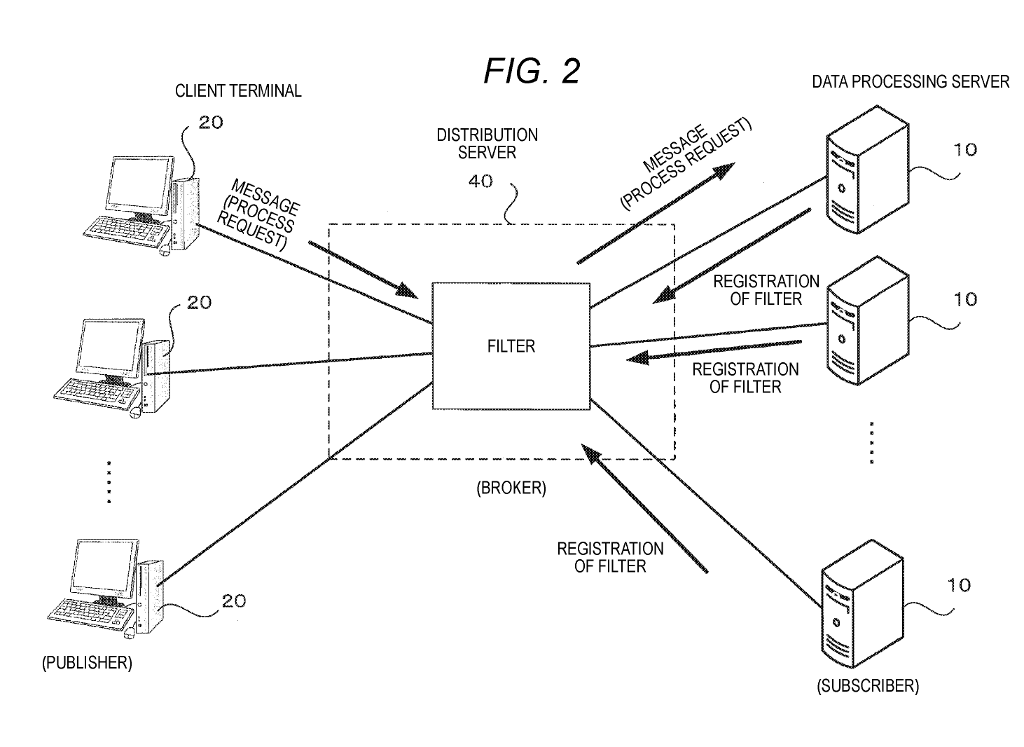

FIG. 2 shows a conceptual view of a transmitting and receiving method in the data distribution system of the first exemplary embodiment of the present invention.

In the data distribution system shown in FIG. 2, the process request is transmitted and received between the client terminal 20 and the data processing server 10 in the form of a Pub/Sub messaging model.

Here, the client terminal 20 functions as a publisher which issues the process request. Further, the distribution server 40 functions as a broker which distributes the process request from the client terminal 20 to the data processing server 10 which can execute the process request. Further, the data processing server 10 functions as a subscriber which receives from the distribution server 40 only the process request whose process is executable in its own apparatus.

A concept of a transmitting and receiving method of the process request in the data distribution system of the present exemplary embodiment which functions as such a Pub/Sub messaging model will be described below by referring to FIG. 2.

Initially, the plurality of data processing servers 10 respectively register information of kinds of the process requests that are executable in their own apparatuses in the distribution server 40 as filters.

Then, when the client terminal 20 transmits the process request whose process contents are specified to the distribution server 40, the distribution server 40 transmits the process request corresponding to the filter registered by the data processing server 10 to the data processing server 10.

By executing such a process, the client terminal 20 does not specify which data processing server 10 the generated process request is to be transmitted to and transmits the generated process request to the data processing server 10 which can execute the process request.

Further, the data processing server 10 does not require a knowledge concerning the client terminal 20 and may receive the process request that is executable by its own apparatus.

Namely, the client terminal 20 and the data processing server 10 do not hold mutual information and the process request generated in the client terminal 20 is properly sent to the data processing server 10 that may execute the process request

When the data processing server 10 completes an execution of the received process request, the data processing server 10 which executes the received process request returns a processed result to the client terminal 20 which generates the received process request as a response message. When the data processing server 10 sends the response message to the client terminal 20, the data processing server 10 functions as a publisher and the client terminal 20 functions as a subscriber.

Here, when the client terminal 20 receives the response message from the data processing server 10, the client terminal 20 grasps the completion of the generated process request.

However, when a plurality of process requests are transmitted to the specific data processing server 10 at the same time, or when a quantity of data to be processed is large, a processing time in the data processing server 10 may be possibly long.

In such a case, although the client terminal 20 transmits the process request, when a process to the transmitted process request is not completed within an expected time, time runs out. Thus, the client terminal 20 determines that the transmitted process request is normally processed, and may probably transmit again the process request having the same process contents.

However, when the data server 10 merely takes a long time to execute the process request or even when the data processing server 10 completes the execution of the process request at last, the data processing server 10 may probably execute the same process request again.

As described above, when processes to the process request having the same process contents are repeatedly executed, a throughput of the data processing server 10 is wastefully consumed and a capacity of a communication line is oppressed.

Thus, in the data distribution system of the present exemplary embodiment, by executing a below-described process, even when the client terminal 20 erroneously transmits the same process requests a plurality of times, an occurrence of wastefulness is prevented that the same process request is repeatedly executed a plurality of times.

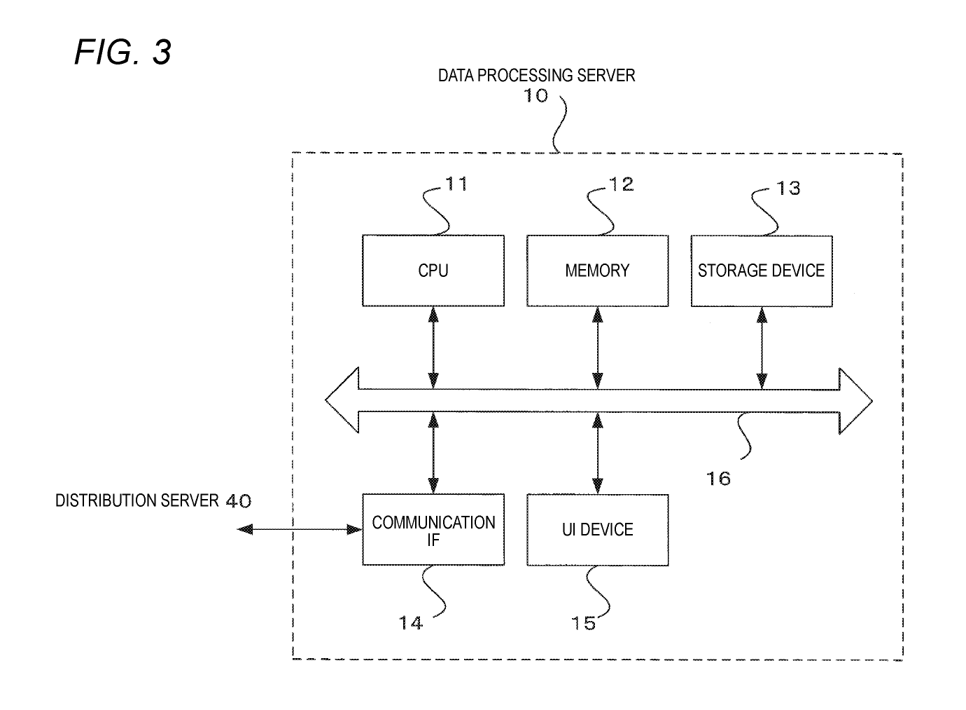

A hardware structure of the data processing server 10 in the data distribution system of the present exemplary embodiment is shown in FIG. 3.

The data processing server 10 includes, as shown in FIG. 3, a CPU 11, a memory 12, a storage device 13 such as a hard disk drive (HDD), a communication interface (IF) 14 which transmits data to and receives data from an external device through a network 30 and a user interface (UI) device 15 including a touch panel, a liquid crystal display and a keyboard. These components are connected together through a control bus 16.

The CPU 11 executes a prescribed process in accordance with a control program stored in the memory 12 or the storage device 13 to control an operation of the data processing server 10. In the present exemplary embodiment, the CPU 11 is explained as a part which reads the control program stored in the memory 12 or the storage device 13 to execute the program. However, the program may be stored in a storing medium such as CD-ROM and supplied to the CPU 11.

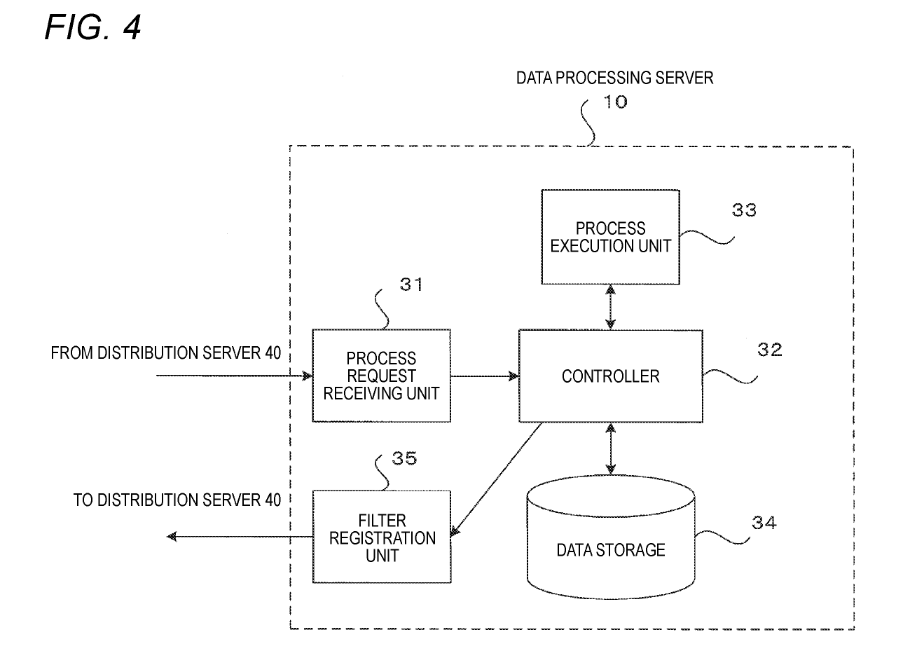

FIG. 4 is a block diagram illustrating a functional structure of the data processing server 10 realized by executing the above-described control program.

The data processing server 10 of the present exemplary embodiment includes, as shown in FIG. 4, a process request receiving unit 31, a controller 32, a process execution unit 33, a data storage 34 and a filter registration unit 35.

The process execution unit 33 executes out a process in accordance with a process request received by the process request receiving unit 31 under the control by the controller 32. For instance, the process execution unit 33 executes out a process to any of data of the image data, the audio data and the text data. The process executed in the process execution unit 33 may be a process to other data than the image data, the audio data and the text data.

The filter registration unit 35 registers information concerning the process request that is executable in the process execution unit 33 in the distribution server 40 which distributes the process request as a filter.

The process request receiving unit 31 receives the process request generated in the client terminal 20 from the distribution server 40 in which the information concerning the process request that is executable is registered as the filter. The process request receiving unit 31 receives, as described above, the process request from the client terminal 20 through the communication protocol that executes the Pub/Sub data distribution.

The controller 32 executes various kinds of controls. For instance, the controller 32 controls the process execution unit 33 to execute the process request received by the process request receiving unit 31 or the filter registration unit 35 to register the filter in the distribution server 40.

The data storage 34 stores various kinds of data such as the process requests whose execution of processes are waited for.

Then, when the process request receiving unit 31 receives the process request, if the process execution unit 33 currently executes a process to other request, or if process contents of the process request which is currently executed are the same as process contents of the process request received by the process request receiving unit 31, the process execution unit 33 does not execute the process of the process request received in the process request receiving unit 31.

Specifically, the controller 32 compares the process contents of the process request which is currently executed with the process contents of the process request received by the process request receiving unit 31 to determine whether or not the process contents are the same. Then, when the controller 32 determines that the process contents of the process request which is currently executed and the process contents of the process request which is received by the process request receiving unit 31 are the same, the controller 32 controls the process execution unit 33 not to execute the process of the process request received in the process request receiving unit 31.

Here, the process contents of the process requests being the same do not indicate a case that data structures of the process requests are completely the same, but mean that the process contents based on the process requests are substantially the same. Specifically, when the process contents such as an image process, an audio process or a text process to the same data to be processed are substantially the same, namely when it is determined that the process contents are duplicated, it is determined that the two process contents are the same.

Accordingly, when information of the process request which is currently executed is the same as information of the process request received by the process request receiving unit 31 except time information, the controller 32 may determine that process contents of the process request which is currently executed is the same as the process contents of the process request received by the process request receiving unit 31

Further, when the controller 32 compares combinations of a plurality of information of process request source information, process contents information, process parameter information, process object data information and processed data storage destination information in the process request which is currently executed and the process request received by the process request receiving unit 31, and the compared combinations of the information are the same, the controller 32 may determine that the process contents of the process request which is currently executed and the process request received by the process request receiving unit 31 are the same.

When the process request is received by the process request receiving unit 31, if the process to other process request is currently executed and the process contents of the process request which is currently executed are not the same as the process contents of the process request which is received by the process request receiving unit 31, namely, when the two process contents are different, the process execution unit 33 executes the process request received in the process request receiving unit 31.

Now, an operation of the data processing server 10 in the data distribution system of the present exemplary embodiment will be described below in detail.

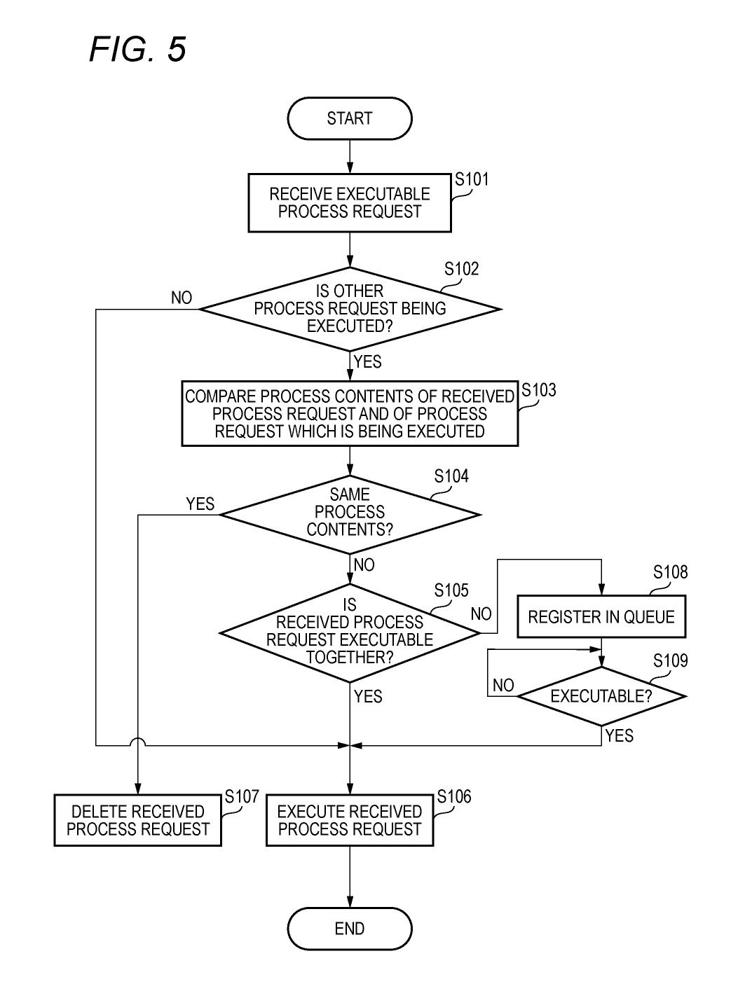

FIG. 5 is a flowchart for explaining the operation of the data processing server 10.

Initially, the process request receiving unit 31 receives the process request whose process is executable in the process execution unit 33 from the distribution server 40 (step S101).

Then, the controller 32 determines whether or not the process execution unit 33 currently executes other process request (step S102).

Here, when the process execution unit 33 does not currently execute other process request (NO in the step S102), the controller 32 controls the process request execution unit 33 to execute the received process request (step S106).

Further, when the process execution unit 33 currently executes other process request (YES in the step S102), the controller 32 compares the process contents of the received process request with the process contents of the process request which is currently executed (step S103).

Then, when the controller 32 determines that the process contents of the received process request and the process request which is currently executed are substantially the same (YES in step S104), the controller 32 does not execute the process request received in the process request receiving unit 31 and deletes the process request (step S107).

Further, when the controller 32 determines that the process contents of the received process request and the process request which is currently executed are not substantially the same (NO in the step S104), if the received process request and the process request which is currently executed can be executed at the same time (YES in step S105), the controller 32 executes the received process request (step S106).

Further, when the received process request and the process request which is currently executed cannot be executed at the same time (NO in the step S105), the controller 32 registers the received process request in a queue (step S108). When the process request which is currently executed is completed and the received process request is executable (YES in step S109), the controller 32 executes the received process request (the step S106).

Next, a data distribution system according to a second exemplary embodiment will be described. In the following second exemplary embodiment, a client terminal is specifically described with respect its structure and its operation, while other components of the data distribution system are common or equivalent to those of the data distribution system according to the first exemplary embodiment. Other components of the data distribution system according to the second exemplary embodiment are common or equivalent to those of the data distribution system according to the first exemplary embodiment and given the same or corresponding reference numerals, and the description thereof will be simplified or omitted.

As discussed above, when the client terminal 20 receives the response message from the data processing server 10, the client terminal 20 grasps the completion of the generated process request. However, when the data processing server 10 which executes the process of the process request which is to be transmitted from the client terminal 20 is currently executing other process request whose processing load is large, even if the client terminal 20 transmits the process request to the data processing server 10, the client terminal may possibly wait for the execution of the process of the process request. In such a case, even if the client terminal 20 transmits the process request, the client terminal 20 cannot receive a response message that the process is completed for some time.

Further, there is no data processing server 10 in the plural data processing servers 10 which can execute the process of the process request to be transmitted, if the process request is transmitted to the distribution server 40, the process request is not executed from the beginning.

In such a case, although the client terminal 20 transmits the process request, when the process to the transmitted process request is not completed within an expected time, time runs out in the client terminal 20. Thus, the client terminal 20 may possibly determine that the transmitted process request is not normally processed to transmit again the process request having the same process contents.

However, when the data processing server 10 cannot execute the process of the process request, even if the process request having the same process contents is transmitted again, a capacity of a communication line of the network 30 or the like is merely wastefully consumed.

Thus, in the data distribution system of the present embodiment, when the process request is transmitted to the data processing server 10 to execute a specific process, it is recognized that the process request to be transmitted is executable in the data processing server 10 at the present moment by executing a process as described below to prevent an occurrence of the above-described wastefulness.

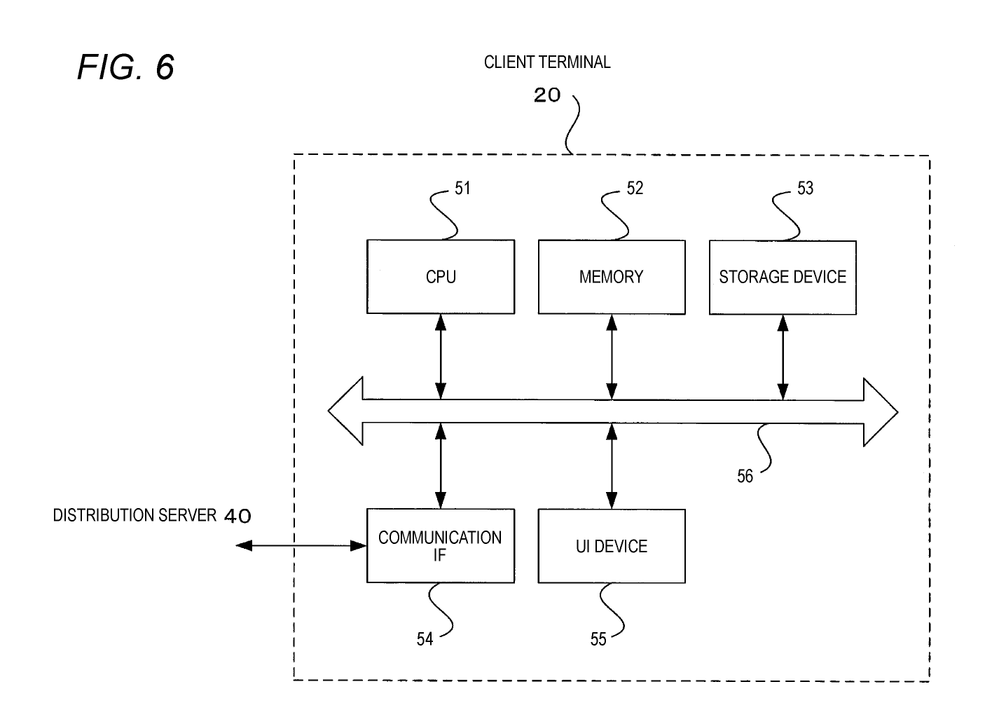

Now, a hardware structure of the client terminal 20 in the data distribution system of the present exemplary embodiment is shown in FIG. 6.

The client terminal 20 includes, as shown in FIG. 6, a CPU 51, a memory 52, a storage device 53 such as a hard disk drive (HDD), a communication interface (IF) 54 which transmits data to and receives data from an external device through a network 30 and a user interface (UI) device 55 including a touch panel or a liquid crystal display and a keyboard. These components are connected together through a control bus 56.

The CPU 11 executes a prescribed process in accordance with a control program stored in the memory 52 or the storage device 53 to control an operation of the client terminal 20. In the present exemplary embodiment, the CPU 51 is explained as a part which reads the control program stored in the memory 52 or the storage device 53 to execute the program.

However, the program may be stored in a storing medium such as CD-ROM and supplied to the CPU 51.

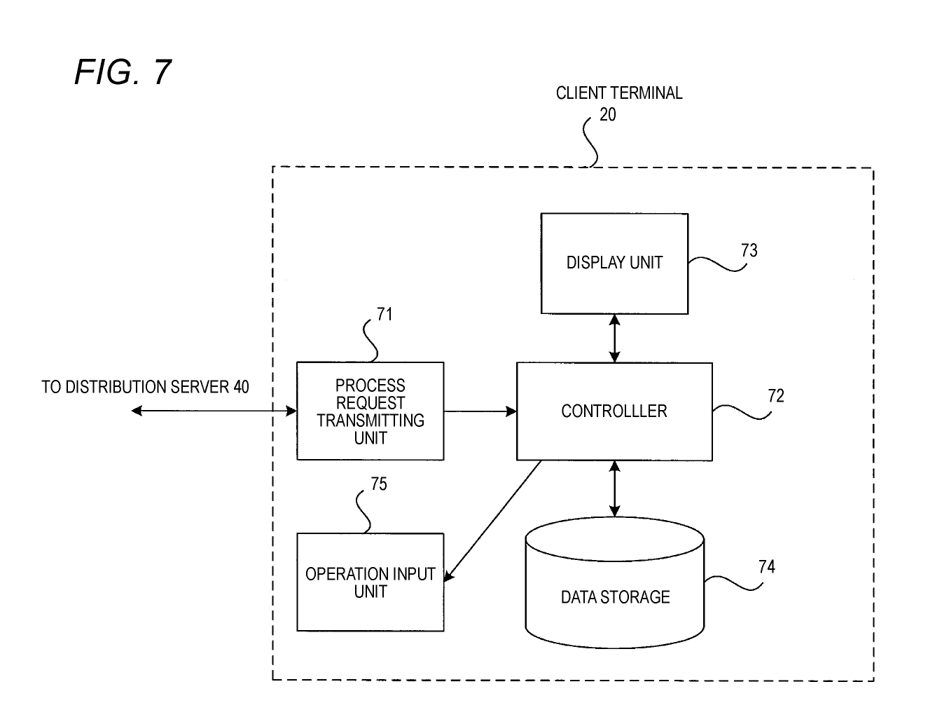

FIG. 7 is a block diagram illustrating a functional structure of the client terminal 20 realized by executing the above-described control program.

The client terminal 20 of the present exemplary embodiment includes, as shown in FIG. 4, a process request transmitting unit 71, a controller 72, a display unit 73, a data storage 74 and an operation input unit 75.

The process request transmitting unit 71 transmits the process request generated in the client terminal 20 to the data processing server 10 as a process execution a through the communication protocol which executes the above-described Pub/Sub data distribution. For instance, the process request transmitting unit 71 transmits any of data of image data, audio data and text data as data to be processed.

The display unit 73 is controlled by the controller 72 to display various kinds of information to a user. The operation input unit 75 inputs various kinds of operation information executed by the user.

The controller 72 executes various kinds of controls such as a process of transmitting the process request in accordance with the various kinds of operation information inputted from the operation input unit 75 or a display of a process result to the transmitted process request on the display unit 73. The data storage 74 temporarily stores the generated process request or stores various kinds of data.

When the process request transmitting unit 71 is about to transmit a process request (a first process request) which executes specific process contents to the data processing server 10, the process request transmitting unit 71 transmits a dummy process request (a second process request) having a processing load smaller than that of the first process request to the data processing server 10. Then, when a process result to the dummy process request in the data processing server 10 is normally obtained, the process request transmitting unit 71 transmits the process request which the process request transmitting unit is about to transmit to the data processing server 10.

Here, the dummy process request is a process request whose process contents to be executed are the same as or similar to those of the process request which is about to be transmitted. For instance, the dummy process request is an imitation process request in which data to be processed is not included. Namely, the dummy process request is a process request for recognizing whether or not the process request which is to be actually transmitted is executable in any of the data processing servers 10 at the present moment.

For instance, when the process request to be actually transmitted is certain image data and a compression process to the image data, the dummy process request may use a process request in which image data to be processed is not included and process contents are a compression process or a process request in which the image data to be processed is temporary image data small in its quantity of data.

The process request transmitting unit 71 does not always transmit the dummy process requests before the process request transmitting unit 71 transmits all the process requests, but may previously transmit the dummy process request only when the process request transiting unit 71 is about to transmit the process request which meets a certain condition.

For instance, when the processing load of the process request which the process request transmitting unit 71 is about to actually transmit is larger than a preset value, the process request transmitting unit 71 transmits the dummy process request before the process request transmitting unit transmits the process request. Namely, when the processing load of the process request which is to be actually transmitted is smaller than the preset value, the process request transmitting unit 71 does not transmit the dummy process request before the process request transmitting unit transmits the process request, but directly transmits the process request which the process request transmitting unit 71 is about is actually transmit.

Further, when a present time is included in a predetermined time period, the process request transmitting unit 71 may transmit the dummy process request before the process request transmitting unit 71 transmits the process request which the process request transmitting unit 71 is about to actually transmit. The above-described operation is done because, for instance, if a communication line such as a network 30 is crowded in a specific time period, only when the process request transmitting unit 71 is about to transmit the process request in that time period the process request transmitting unit 71 previously transmits the dummy process request to recognize that the process request is transmitted to the data processing server 10 without a problem due to the crowdedness of the communication line.

Further, information that a process result to a process request whose process contents are the same as or similar to those of the process request which is to be actually transmitted is not normally obtained is included in history information of the past process results, the process request transmitting unit 71 may transmit the dummy process request before the process request transmitting unit 71 transmits the process request.

Specifically, the history information of the process results of the process requests which are transmitted in the past is stored in the data storage 74. When the controller 72 is about to transmit the process request through the process request transmitting unit 71, the controller 72 refers to the history information to obtain the process result of the process request whose process contents are the same as or similar to those of the process request. Then, the controller 72 refers to the obtained history information, and, when the process requests the same as or similar to the process request to be transmitted shows an error in the past, the controller 72 transmits the dummy process request before transmitting the process request to previously recognize whether or not the data processing server 10 can process the process request to be transmitted.

As a method for deciding whether or not the process result to the transmitted process request is normally obtained, there are various methods.

For instance, when the process request transmitting unit 71 cannot obtain a response that the process to the dummy process request is normally executed within a preset time, the process request transmitting unit 71 determines that the process result is not normally obtained.

Further, when the process request transmitting unit 71 cannot obtain the process result to the dummy process request, the process request transmitting unit 71 transmits again the dummy process request after a preset time. When the number of times of transmissions of the dummy process request exceeds a preset number of times, the process request transmitting unit 71 may determine that the process result is not normally obtained.

Now, an operation of the client terminal 20 in the data distribution system of the present exemplary embodiment will be described below in detail.

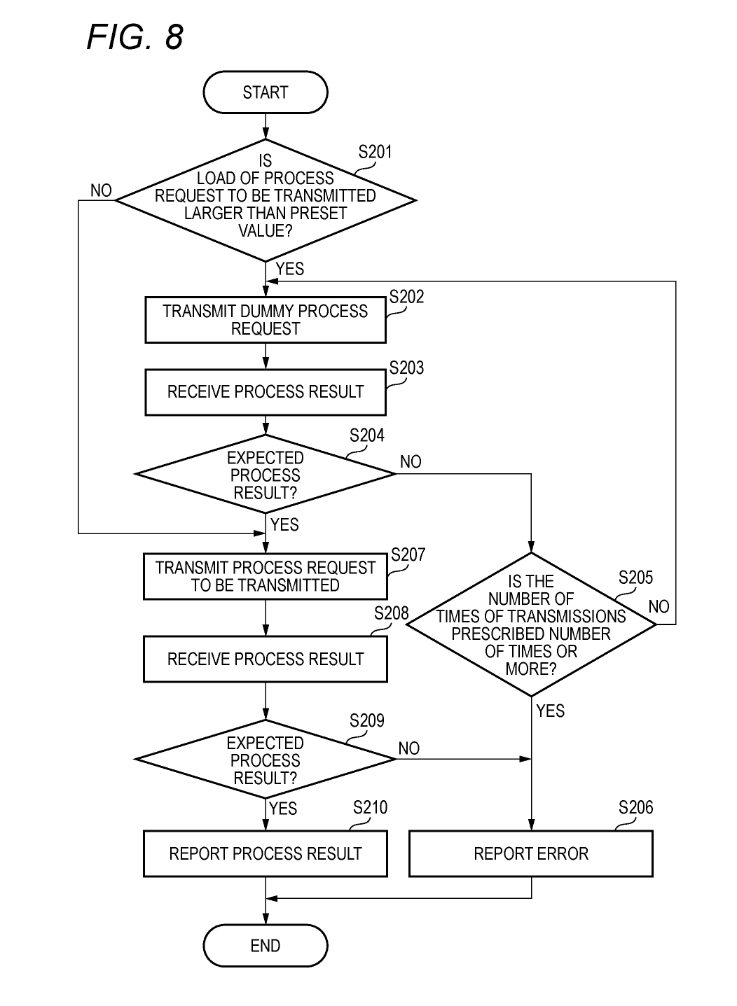

FIG. 8 is a flowchart for explaining the operation of the client terminal 20. In the flowchart shown in FIG. 8, a case will be described that only when the processing load of the process request to be transmitted is larger than a preset value, the dummy process request is transmitted.

Initially, the controller 72 determines whether or not the processing load of the process request to be transmitted to the data processing server 10 is larger than the preset value (step S201).

Here, when the processing load of the process request to be transmitted is not larger than the preset value (NO in the step S201), the process request transmitting unit 71 directly transmits the process request which the process request transmitting unit 71 is about to transmit to the distribution server 40 (step S207).

Then, when the processing load of the process request which is to be about to be transmitted is larger than the preset value (YES in the step S201), the process request transmitting unit 71 transmits the dummy process request whose processing load is smaller than that of the process request to the distribution server 40 (step S202).

Then, when the controller 72 receives the process result to the transmitted dummy process request from the data processing server 10 (step S203), the controller 72 determines whether or not the received process result is an expected process result (step S204).

Here, whether or not the expected process result is obtained is determined, for instance, in accordance with whether or not a predetermined process result is obtained within a preset time after the dummy process request is transmitted.

Then, when the received process result is not the expected process result (NO in the step S204), the process request transmitting unit 71 repeats the transmission of the dummy process request until the number of times of transmissions is prescribed times or more (step S205). Then, when the number of times of transmissions of the dummy process request is the prescribed times or more (YES in the step S205), the controller 72 gives an error report to a user through the display unit 73 (step S206).

Here, the prescribed times do not need to be set to a plurality of times. When the prescribed times is set to one time and the process result to the dummy process request is not the expected process result even once, the error report is given to the user.

Further, when the received process result is the expected process result (YES in the step S204), the process request transmitting unit 71 transmits the process request which is initially to be transmitted to the distribution server 40 (step S207).

Then, the controller 72 receives the process result to the transmitted process request (step S208). When the received process result is the expected process result (YES in step S209), the controller 72 reports the process result to the user by displaying it on the display unit 73 (step S210).

When the received process result is not the expected process result (NO in the step S209), the controller 72 gives an error report to the user by displaying the process result on the display unit 73 (the step S206).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a receiving unit that receives a process request; and
a process execution unit that executes a process in accordance with the process request received by the receiving unit, wherein,
in a case where, while the process execution unit is executing a process in accordance with a process request, the receiving unit receives another process request a process content in accordance with which being same as a process content of the process request that is being executed, the process execution unit does not execute the other process request received by the receiving unit.

2. The information processing apparatus according to claim 1, wherein,
in a case where, while the process execution unit is executing the process in accordance with the process request, the receiving unit receives an additional process request a process content in accordance with which not being same as a process content of the process request that is being executed, the process execution unit executes the additional process request received by the receiving unit.

3. The information processing apparatus according to claim 1, further comprising
a determining unit that compares the process content in accordance with the process request that is being executed with a process content of a process request received by the receiving unit and determines whether the process content in accordance with the process request that is being executed and the process content in accordance with the process request received by the receiving unit are same, wherein,
in a case where the determining unit determines that the process content in accordance with the process request that is being executed and the process content in accordance with the process request received by the receiving unit are same, the process execution unit does not execute the process request received by the receiving unit.

4. The information processing apparatus according to claim 3, wherein,
the determining unit determines that the process content in accordance with the process request that is being executed and the process content in accordance with the process request received by the receiving unit are same in a case where information included in the process request that is being executed other than time information is identical to information included in the process request received by the receiving unit other than time information.

5. The information processing apparatus according to claim 3, wherein
the determining unit compares a combination of pieces of information including process request source information, process content information, process parameter information, process object data information and processed data storage destination information in the process request that is being executed and a combination of pieces of information including process request source information, process content information, process parameter information, process object data information and processed data storage destination information in the process request received by the receiving unit, and determines that the process content in accordance with the process request that is being executed and the process content in accordance with the process request received by the receiving unit are same in a case where the combination of the pieces of the information in the process request that is being executed and the combination of the pieces of the information in the process request received by the receiving unit are same.

6. The information processing apparatus according to claim 1, further comprising
a registration unit that registers information regarding a process request that is executable by the process execution unit in a server apparatus, the server apparatus distributing the process request, wherein
the receiving unit receives the process request from the server apparatus in which the information regarding the process request which is executable is registered.

7. The information processing apparatus according to claim 6, wherein
the receiving unit receives the process request through a communication protocol that provides Pub/Sub data distribution from a client terminal.

8. The information processing apparatus according to claim 1, wherein
the process execution unit executes the process to image data, audio data or text data.

9. A data distribution system comprising:
a client terminal that generates and transmits a process request;
a server apparatus that receives the process request from the client terminal and transmits the process request to an information processing apparatus that is configured to execute the process request received; and
an information processing apparatus including
a receiving unit that receives the process request from the server apparatus and
a process execution unit that executes a process in accordance with the process request received by the receiving unit; wherein,
in a case where, while the process execution unit is executing a process in accordance with a process request, the receiving unit receives another process request a process content in accordance with which being same as a process content of the process request that is being executed, the process execution unit does not execute the other process request received by the receiving unit.

10. A non-transitory computer readable medium storing a program causing a computer to execute a process, the process comprising:
receiving a process request; and
executing a process in accordance with the process request received; wherein,
in a case where, while a process in accordance with a process request is being executed, another process request is received, a process content in accordance with the other process request being same as a process content of the process request that is being executed, the other process request received is not executed.

11. An information processing apparatus comprising:
a first transmitting unit that, when a first process request for executing a process content is about to be transmitted to a process execution apparatus that executes a process in accordance with a received process request, transmits a second process request a processing load of which is smaller than a process load of a first process request; and
a second transmitting unit that transmits the first process request to the process execution apparatus in a case where a process result to the second process request in the process execution apparatus is normally obtained.

12. The information processing apparatus according to claim 11, wherein
a process content in accordance with the second process request is same as or similar to a process content in accordance with the first process request.

13. The information processing apparatus according to claim 12, wherein
the second process request is an imitative process request in which data to be processed are not included.

14. The information processing apparatus according to claim 11, wherein,
in a case where a processing load of the first process request is larger than a preset value, the first transmitting unit transmits the second process request before the first process request is transmitted.

15. The information processing apparatus according to claim 11, wherein,
in a case where a processing load of the first process request is smaller than a preset value, the first transmitting unit transmits the first process request and the second transmit unit does not transmit the second process request before the first transmitting unit transmits the first process request, but transmits the first process request.

16. The information processing apparatus according to claim 11, wherein,
in a case where a current time is included in a predetermined time period, the first transmitting unit transmits the second process request before the first process request is transmitted.

17. The information processing apparatus according to claim 11, wherein,
in a case where information indicating that a process result to a process request having a process content being same as or similar to the process content of the first process request is not normally obtained is included in history information regarding a past process result, the first transmitting unit transmits the second process request before the first process request is transmitted.

18. The information processing apparatus according to claim 11, wherein,
the second transmitting unit determines that the process result is not normally obtained in a case where a response indicating a process in accordance with the second process request is normally executed is not obtained within a preset time.

19. The information processing apparatus according to claim 11, wherein,
in a case where the process result to the second process request is not obtained, the first transmitting unit transmits the second process request again after a preset time.

20. The information processing apparatus according to claim 19, wherein,
in a case where a number of times the second process request is transmitted exceeds a preset number, the second transmitting unit determines that the process result to the second process request is not normally obtained.

21. The information processing apparatus according to claim 11, wherein,
the first transmitting unit and the second transmitting unit transmit the first process request or the second process request to the process execution apparatus through a communication protocol that provides Pub/Sub data distribution.

22. The information processing apparatus according to claim 11, wherein
the first transmitting unit and the second transmitting unit transmit the first process request or the second process request having any of data of image data, audio data and text data as data to be processed.

23. A data distribution system comprising:
a process execution apparatus that executes a process in accordance with a received process request, and
a server apparatus that distributes the process request that is executable to the process execution apparatus, and
an information processing apparatus including a first transmitting unit that, when a first process request for executing a process content is about to be transmitted to a process execution apparatus that executes a process in accordance with a received process request, transmits a second process request a processing load of which is smaller than a process load of a first process request; and a second transmitting unit that transmits the first process request to the process execution apparatus in a case where a process result to the second process request in the process execution apparatus is normally obtained.

24. A non-transitory computer readable medium storing a program causing a computer to execute a process, the process comprising:
transmitting, when a first process request for executing a process content is about to be transmitted to a process execution apparatus that executes a process in accordance with a received process request, a second process request a processing load of which is smaller than a process load of a first process request; and
transmitting the first process request to the process execution apparatus in a case where a process result to the second process request in the process execution apparatus is normally obtained.
